(19) United States
(12) Patent Application Publication
(10) Pub. No.: US 2011/0168532 A1
(43) Pub. Date: Jul. 14, 2011

(54) PRESS-KEY WITH LOW LIGHT DIFFUSING DESIGN AND KEYBOARD USING THE SAME

(75) Inventors: WEN-YU TSAI, Changhua County (TW); Ta-Yi Huang, Changhua County (TW)

(73) Assignee: Darfon Electronics Corp., Taoyuan (TW)

(21) Appl. No.: 12/985,869

(22) Filed: Jan. 6, 2011

(30) Foreign Application Priority Data
Jan. 8, 2010 (TW) 099200386

(51) Int. Cl. H01H 9/00

(52) U.S. Cl. 200/314

(57) ABSTRACT

A press-key with low light diffusing design, adapted to be received inside a frame of a keyboard, is disclosed, which comprises: a substrate; a keycap, formed with a light-transmissive part, being mounted on the substrate while enabling the same to move vertically up and down in relative to the substrate; a light-emitting unit, disposed inside the keycap at a position below the light-transmissive part; and a light mask, made of an opaque material and being formed as an upward-extending wall surrounding the circumference of the light-emitting unit while allowing an opening to be formed on top thereof at a position corresponding to the light-transmissive part and thus allowing the light emitted from the light-emitting unit to be projected out of the light mask only through the opening of the same and thus to be emanating out of the keycap only through the light-transmissive part.

### FIELD OF THE INVENTION

The present invention relates to a keyboard, and more particularly, to a press-key with low light diffusing design and a keyboard using the same that are capable of emanating light only through a light-transmissive part formed on its keycap.

### BACKGROUND OF THE INVENTION

Please refer to FIG. 6, which shows a conventional keyboard structure. As shown in FIG. 6, for allowing certain press-keys on the keyboard 8 to emanate light for recognition while the keyboard 8 is being activated, they are usually being configured with windows at the keycaps thereof, such as the window 811 on the keycap 810 of the press-key 81. In addition, taking the press-key 811 for instance, it is further configured with a light-emitting unit 813, which can be a light-emitting diode (LED), on the substrate 812 of the press-key 81 at a position corresponding to the window 811 for allowing the light from the light-emitting unit 813 to be projected out of the keycap 810 of the press-key 81 through the window 811, and thus, enabling the press-key 81 to be easily distinguishable and also the other such press-keys with windows as well. It is noted that, for clarity, the mechanism including the supporting components and elastic components that is used for supporting the keycap is not shown in FIG. 6.

Since light being given off from a common light source is usually being discharged in a diffused manner, the intensity of light that travels passing through the window 811 on the keycap 810 is weakened. Consequently, for ensuring the legibility of the press-key 81, high-power light-emitting unit is required for enabling the intensity of light travelling passing through the window 811 to increase and thus enabling the press-key 81 to be easily distinguishable or legible.

However, the use of such high-power light-emitting units for enhancing legibility can be problematic. First of all, not only those high-power light-emitting units can be comparatively more expensive, but also the power consumptions those high-power light-emitting units are mush higher. Secondly, since the aforesaid windows are generally being built into their corresponding keycaps, and thus, for ensuring the windows to be integrated with the keycaps fixedly and securely, each of such windows is usually being constructed as a panel having a transparent island protruding at the middle thereof that is provided for allowing light to be projected out therethrough, and a skirt portion, being the portion of the panel surrounding the island, that is provided to be embedded into the corresponding keycap, the portion of the keycap surrounding its window that is provided for the skirt portion of the window to embedded therein is usually being formed thinner than other portions of the keycap. Consequently, when a light-emitting unit is activated for emitting light, the light not only will be projected out of its corresponding transparent window, but also a portion of such light will also being diffused and travelling passing through the thinner portion of the keycap, and thus, the aesthetic perception enabled by the light projected out of the transparent window is spoiled. Moreover, such problem of undesirable light diffusing surrounding the transparent windows is especially severe for those while press-keys. Therefore, it is in need of an improved press-key structure for eliminating the aforesaid light diffusion problem.

### SUMMARY OF THE INVENTION

In view of the disadvantages of prior art, the primary object of the present invention is to provide a press-key with low light diffusing design and a keyboard using the same, in that a light mask is arranged corresponding to a light-transmissive part of the keycap of the press-key so as to enable light projected out the opening of the mask to be emanating out of the keycap only through the light-transmissive part without being diffused by other portions of the keycap, and thus enabling the legibility of the press-key to be enhanced.

To achieve the above object, the present invention provides a press-key with low light diffusing design, adapted to be received inside a frame of a keyboard, comprising: a substrate; a keycap, formed with a light-transmissive part and being mounted on the substrate while enabling the same to move vertically up and down in relative to the substrate; a light-emitting unit, disposed inside the keycap at a position below the light-transmissive part; and a light mask, made of an opaque material and being formed as an upward-extending wall surrounding the circumference of the light-emitting unit while allowing an opening to be formed on top thereof at a position corresponding to the light-transmissive part and thus allowing the light emitted from the light-emitting unit to be projected out of the light mask only through the opening of the same and thus to be emanating out of the keycap only through the light-transmissive part.

Preferably, the light mask is made of an elastic material, such as rubber.

Preferably, the light mask is constructed as cone-shaped structure.

Preferably, the light-transmissive part is made of a transparent material.

Moreover, the light mask can be replaced by a light-shielding element, whereas the light shielding element can be made of an opaque material and is formed on the bottom of the light-transmissive part while allowing an opening of the same to be arranged at a position corresponding to the light-transmissive part for enabling the light emitted from the light-emitting unit to be projected out of the light-shielding element only through the opening of the same and thus to be emanating out of the keycap only through the light-transmissive part.

Preferably, the light-shielding element is made of a polyester thin film.

Preferably, the light-shielding element is formed on the bottom of the light-transmissive part by printing.

Preferably, the light-shielding element is formed on the bottom of the light-transmissive part by spray painting.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is an exploded view of a press-key of the invention that is mounted on a keyboard according to a first embodiment of the present invention.

FIG. 2 is a cross sectional view of a press-key according to the first embodiment of the present invention.

FIG. 3 is a schematic diagram showing a press-key of the invention that is in operation.

FIG. 4 is an exploded view of a press-key of the invention that is mounted on a keyboard according to a second embodiment of the present invention.

FIG. 5 is a cross sectional view of an operating press-key according to the second embodiment of the present invention.

FIG. 6 shows a conventional keyboard structure.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

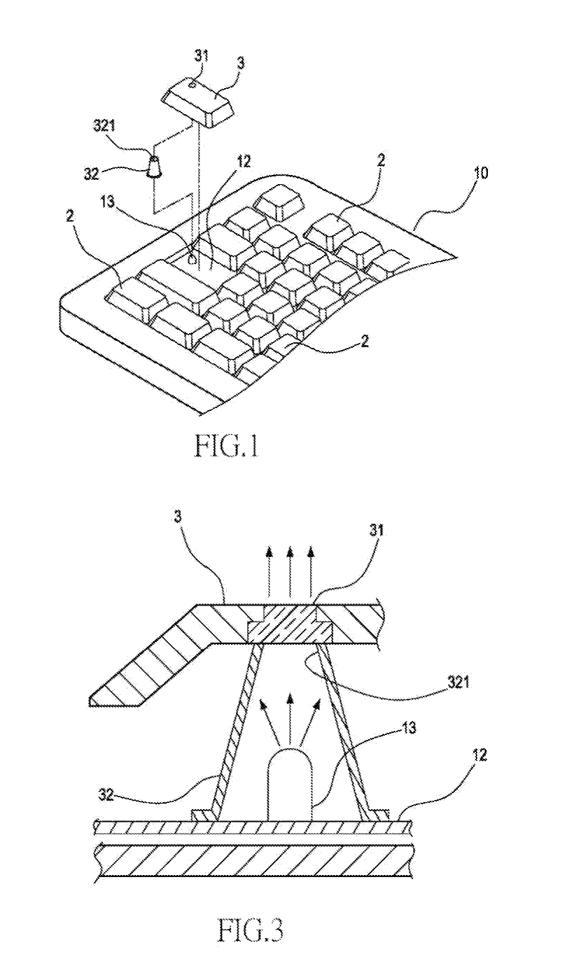

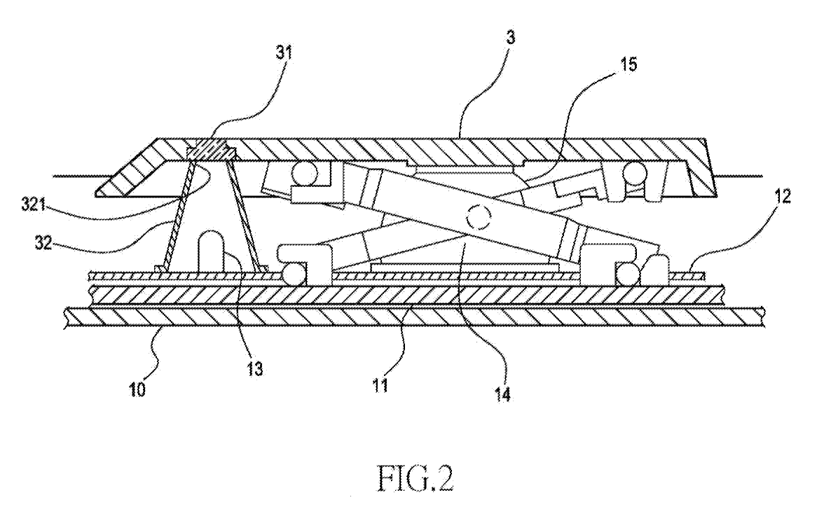

Please refer to FIG. 1 to FIG. 3, which are an exploded view of a press-key of the invention that is mounted on a keyboard according to a first embodiment of the present invention; a cross sectional view of a press-key according to the first embodiment of the present invention; and a schematic diagram showing a press-key of the invention that is in operation.

As shown in FIG. 1, a keyboard having press-keys with low light diffusing design is composed of: a frame 12, adapted for having a plurality of keycaps 2 to be received therein; a substrate 11, received inside the frame 10; and a circuit board 12 disposed on the substrate 11, wherein, there is a light-emitting unit 13 disposed on the circuitboard 12 at a position corresponding to a specific keycap 3 selected from the plural keycaps 2, while enabling a supporting mechanism 14 and an elastic element 15 to be positioned between each of the keycaps 2 and the substrate 11 that are to be used for enabling the corresponding keycaps 2 to move vertically up and down in relative to the substrate 11. It is noted that the supporting mechanism 14 and the elastic element 15 are not illustrated in FIG. 1 so as to show the light-emitting unit 13.

The specific keycap 3 is formed with a light-transmissive part 31 at a position corresponding to the light-emitting unit 13, and the light-transmissive part 31 is made of a transparent material. Moreover, There is a light mask 32, being made of an opaque material, such as rubber, that is formed as a cone-shaped structure surrounding the circumference of the light-emitting unit 13 while allowing an opening 321 to be formed on top thereof at a position corresponding to the light-transmissive part 31 in a size about the same as the smallest area of the light-transmissive part 31 and thus allowing the light emitted from the light-emitting unit 13 to be projected out of the light mask 32 only through the opening 321 of the same and thus to be emanating out of the keycap 3 only through the light-transmissive part 31.

As shown in FIG. 3, when the light-emitting unit 13, such as a light-emitting diode, is activate to emit light, the travelling of the light will be restricted by the light mask 32 for allowing the same to travel toward the light-transmissive part 31 only through the opening 321, and also by the restriction of the light mask 32, the light emitted from the light-emitting unit 13 can only be projected out of the keycap 3 through the light-transmissive part 31. Thereby, the aforesaid light diffusing problem can be avoided and the eligibility of the keycap is improved.

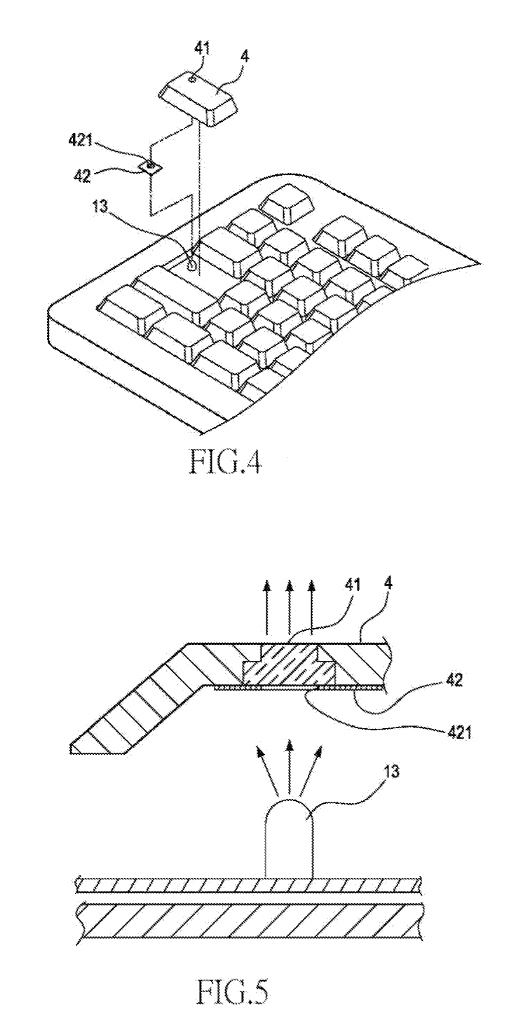

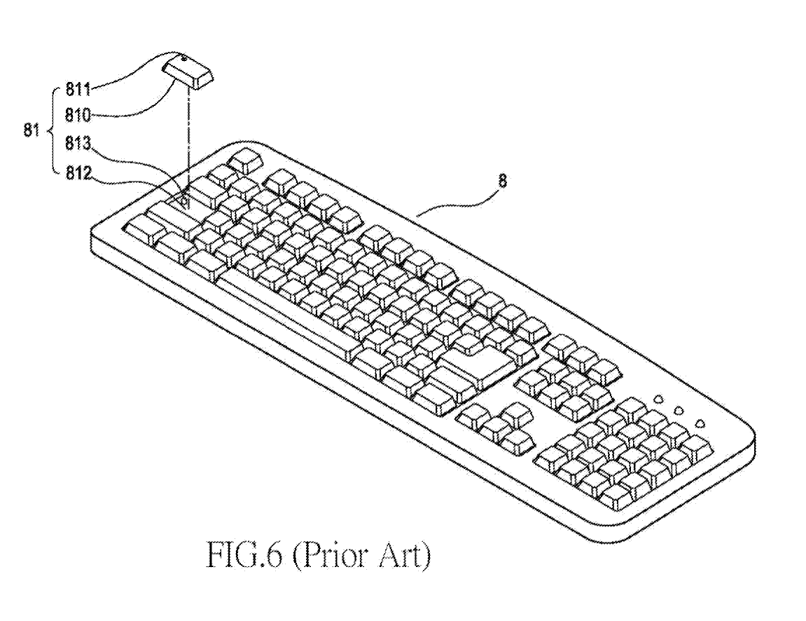

Please refer to FIG. 4 and FIG. 5, which are an exploded view of a press-key of the invention that is mounted on a keyboard according to a second embodiment of the present invention; and a cross sectional view of an operating press-key according to the second embodiment of the present invention. In this embodiment, the light mask in the first embodiment is replaced by a light-shielding element 42, which is also made of an opaque material and is formed on the bottom of the light-transmissive part 41 while allowing an opening 421 of about the same size as the smallest area of the light-transmissive part 41 to be arranged at a position corresponding to the light-transmissive part 41 for enabling the light emitted from the light-emitting unit 13 to be projected out of the light-shielding element 42 only through the opening 421 of the same and thus to be emanating out of the keycap 4 only through the light-transmissive part 41. It is noted that the outer periphery of the light-shielding element 42 should be aligned exactly with the outer periphery of the light-transmissive part 41. Clearly, the press-key of the second embodiment can achieve the same functionality as that of the first embodiment.

It is noted that the light-shielding element 42 can be formed as a sheet-like structure made of an opaque thin film, such as polyester thin film, to be attached to the bottom of the light-transmissive part 41, as the one shown in FIG. 4; or it can be made of an opaque ink that is to be formed on the bottom of the light-transmissive part 41 by printing; or it can be made of an opaque paint that is to be formed on the bottom of the light-transmissive part 41 by spray painting. Nevertheless, no matter how the light-shielding element 42 is formed, it is used for shielding any light from penetrating the same.

It is noted that the light mask of the first embodiment is capable of being used in conjunction with the light-shielding element 42 of the second embodiment, by that the aforesaid light diffusing problem can further be avoided and the eligibility of the keycap is improved.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A press-key with low light diffusing design, comprising:
a substrate;
a keycap, formed with a light-transmissive part, being mounted on the substrate while enabling the same to move vertically up and down in relative to the substrate;
a light-emitting unit, disposed inside the keycap at a position below the light-transmissive part; and
a light mask, made of an opaque material and being formed as an upward-extending wall surrounding the circumference of the light-emitting unit while allowing an opening to be formed on top thereof at a position corresponding to the light-transmissive part and thus allowing the light emitted from the light-emitting unit to be projected out of the light mask only through the opening of the same and thus to be emanating out of the keycap only through the light-transmissive part.

2. The press-key of claim 1, wherein the light mask is made of an elastic material.

3. The press-key of claim 2, wherein the elastic material is rubber.

4. The press-key of claim 1, wherein the light mask is constructed as a cone-shaped structure.

5. The press-key of claim 1, wherein the light-transmissive part is made of a transparent material.

6. A keyboard having press-keys with low light diffusing design, comprising:
a substrate;
a circuitboard, disposed on the substrate, provided for a plurality of light-emitting units to mount thereon; and
a plurality of press-keys; disposed respectively on the circuitboard, each further comprising:
a light-transmissive part, arranged at a position corresponding to its corresponding light-emitting unit; and
a light mask, made of an opaque material and being formed as an upward-extending wall surrounding the circumference of the corresponding light-emitting unit while allowing an opening to be formed on top thereof at a position corresponding to its corresponding light-transmissive part and thus allowing the light emitted from the light-emitting unit to be projected out of the light mask only through the opening of the same and thus to be emanating out of the keycap only through the light-transmissive part.

7. The keyboard of claim 6, wherein the light mask is made of an elastic material.

8. The keyboard of claim 7, wherein the elastic material is rubber.

9. The keyboard of claim 6, wherein the light mask is constructed as a cone-shaped structure.

10. The keyboard of claim 6, wherein the light-transmissive part is made of a transparent material.

11. A press-key with low light diffusing design, comprising:
a substrate;
a keycap, formed with a light-transmissive part, being mounted on the substrate while enabling the same to move vertically up and down in relative to the substrate;
a light-emitting unit, disposed inside the keycap at a position below the light-transmissive part; and
a light-shielding element, made of an opaque material and being formed on the bottom of the light-transmissive part while allowing an opening of the same to be arranged at a position corresponding to the light-transmissive part for enabling the light emitted from the light-emitting unit to be projected out of the light-shielding element only through the opening of the same and thus to be emanating out of the keycap only through the light-transmissive part.

12. The press-key of claim 11, wherein the light-shielding element is made of a polyester thin film.

13. The press-key of claim 11, wherein the light-shielding element is formed on the bottom of the light-transmissive part by printing.

14. The press-key of claim 11, wherein the light-transmissive part is made of a transparent material.

15. The press-key of claim 11, wherein the light-shielding element is formed on the bottom of the light-transmissive part by spray painting.

16. A keyboard having press-keys with low light diffusing design, comprising:
a substrate;
a circuitboard, disposed on the substrate, provided for a plurality of light-emitting units to mount thereon; and
a plurality of press-keys; disposed respectively on the circuitboard, each further comprising:
a light-transmissive part, arranged at a position corresponding to its corresponding light-emitting unit; and
a light-shielding element, made of an opaque material and being formed on the bottom of the light-transmissive part while allowing an opening of the same to be arranged at a position corresponding to the light-transmissive part for enabling the light emitted from the light-emitting unit to be projected out of the light-shielding element only through the opening of the same and thus to be emanating out of the keycap only through the light-transmissive part.

17. The keyboard of claim 16, wherein the light-shielding element is made of a polyester thin film.

18. The keyboard of claim 16, wherein the light-shielding element is formed on the bottom of the light-transmissive part by printing.

19. The keyboard of claim 16, wherein the light-transmissive part is made of a transparent material.

20. The keyboard of claim 16, wherein the light-shielding element is formed on the bottom of the light-transmissive part by spray painting.
